(19) United States
(12) Patent Application Publication
(10) Pub. No.: US 2007/0110845 A1
(43) Pub. Date: May 17, 2007

(54) STANDARD LOAVES, PROCESS AND INSTALLATION FOR OBTAINING THEM

(75) Inventors: Javier Llavina Nadal, Granollers (ES); Josep M. Aguila Plassa, Barcelona (ES)

Correspondence Address: DARBY & DARBY P.C., P. O. BOX 5257, NEW YORK, NY, 10150-5257, US

(73) Assignee: BIMBO, S.A., Barcelona (ES)

(21) Appl. No.: 11/560,639

(22) Filed: Nov. 16, 2006

(30) Foreign Application Priority Data
Nov. 16, 2005 (ES) 200502806

(51) Int. Cl. A21D 8/02

(52) U.S. Cl. 426/19

(57) ABSTRACT

Process for obtaining standard loaves which includes the introduction of a mould containing a leavened bread dough into a baking area, characterised in that baking is carried out, at least in part, at a temperature of between 90 and 150° C.

### CROSS-REFERENCE TO RELATED APPLICATIONS

This application claims priority to Spanish patent application Ser. No. 200502806 filed Nov. 16, 2005, the contents of which are hereby incorporated by reference in its entirety.

### DESCRIPTION

The present invention relates to standard loaves having novel characteristics and to a process and installation for obtaining them.

The consumer perceives the crust of standard loaves as a drawback owing to its differing characteristics, compared to the crumb of the bread, these characteristics resulting from the toasting which occurs during the baking process. In particular, the crust of traditional standard loaves has a bitter taste which is rejected by numerous consumers. According to research carried out by the applicant, some 90% of consumers stated that they had sometimes removed the crust from standard loaves, while more than 50% stated that they do so regularly. In recent years, therefore, there has been a proliferation of loaves for sale, from which the crust has previously been cut.

However, removal of the crust by cutting involves the addition of an extra operation and the creation of waste, and this makes the product more expensive.

The applicant has accordingly investigated the method of obtaining loaves which do not have a crust that may be considered to be a drawback by the consumer, with the resultant satisfaction for the consumer and a saving of costs for the consumer and for the manufacturer.

The applicant declares, in accordance with Article 5.2.c) of the Rules for the implementation of the Spanish patent law, that it does not know of any other prior art which is relevant to this application.

In accordance with the investigations carried out by the inventors, the rejection of the crust by consumers is due to its differing characteristics from the remainder of standard loaves. In particular, the crust has a texture, colour, moisture content, elasticity and organoleptic properties which differ on account of the dehydration and toasting of the external layer of the bread dough which is produced during the baking process (usually at a temperature of approximately 215 to 230° C.)

In order to solve the above-described problems, the present invention consists of a process for obtaining standard loaves which comprises, at least, baking a leavened bread dough introduced into a mould, which is characterised in that baking is carried out, at least in part, at a temperature of between 90° C. and 150° C., and more preferably between 100° C. and 125° C. In even more preferred embodiments, steam can be introduced at temperatures of between more than 100° C. and 125° C., and even more preferably between more than 103° C. and 125° C.

Preferably, the process will comprise a stage of introducing water vapour into the baking area. In a preferred embodiment, the steam is introduced into the baking area surrounding the leavened standard loaf dough at a temperature higher than the saturation temperature at the pressure at which baking is taking place, to avoid undesirable condensation over the dough.

Baking can be carried out in one or more steps. In addition, the steam introduction stage can be carried out in various ways. For example, baking can be carried out with steam, in a manner similar to that which takes place in an autoclave, with the constant presence and introduction of steam, or can be carried out solely with the initial presence of steam. For this purpose, a conventional baking area, or a part of it, will initially be filled with steam, the dough will be introduced and baking will proceed by heating using conventional means such as convection or thermal radiation. In specific preferred embodiments, the steam will be the element responsible for heating the leavened moulded dough, at least during a stage of baking.

Logically, the baking time will vary as a function of the heated dough and the baking parameters. Generally, the preferred baking times will be between 0.5 hours and 1.17 hours. Even more preferably, the baking stage with introduction of steam can last between 0.5 hours and 0.94 hours, and in even more preferred embodiments, between 0.58 hours and 0.75 hours.

As mentioned, differing steps of baking can be combined with the aim of saving time or varying the final properties of the product. For example, baking could be carried out in a stage with initial introduction of steam at a temperature of between 90° C. and 125° C. for a period of between 0.83 hours and 1.17 hours or, alternatively, in a first stage of baking with the constant presence of steam (baking in an autoclave), in which the steam is responsible for heating the bread dough, at a temperature of between 100° C. and 125° C. for a period of between 0.54 hours and 0.75 hours, combined with a second stage in a conventional oven to give consistency to the product at a temperature of between 120° C. and 150° C. for a period of between 0.08 hours and 0.17 hours. This second stage could be carried out in the initial presence of steam to facilitate subsequent demoulding of the product.

The invention also comprises an installation for the industrial production of the standard loaves of the invention which comprises at least a heating unit for baking the bread dough equipped with a device for introducing steam into the baking area. In a preferred embodiment, said installation comprises a steam heating unit such as an autoclave. Said installation could also comprise stations for weighing ingredients, kneading, dividing the dough, shaping, leavening at controlled temperature and humidity before the heating unit or units for baking the bread dough, as well as slicing, packaging and labelling installations located after the heating unit for baking the bread. The terms “before” and “after” in this context refer to the path travelled by bread dough along the imaginary production line.

The present invention also discloses loaves which are characterised in that they have an external crust of which the colour is substantially the same as that of the interior. The organoleptic properties of the crust of the loaves according to the present invention are substantially identical to those of the crumb. The moisture content of the crust is substantially identical to that of the crumb. Consequently, the crumb is not tough, and this additionally distinguishes it from traditional standard loaves and make the product easier to masticate. In addition, steaming can give the external crust a characteristic shine, depending on the baking parameters employed to make it more attractive.

Practical non-limiting examples of preferred methods of carrying out the invention are given hereinafter.

### EXAMPLE 1

A mixture of enriched flour for standard loaves, salt, yeast, drinkable water and vegetable oil (olive oil) in typical proportions for standard loaves of a known type was mixed and kneaded.

500 grams of the mixture were separated and weighed and were introduced into a standard loaf mould. Said mould was left in temperature and humidity conditions controlled so as to allow leavening of the dough, under conditions known for conventional standard loaves.

Subsequently, a conventional laboratory oven was preheated to approximately 100° C. and, when the oven stabilised at said temperature, water vapour generated by an autoclave was introduced into the oven until the oven area was occupied by the water vapour. The mould containing the leavened dough was then introduced into the oven with the steam and was maintained at a temperature of approximately 100° C. for approximately 60 minutes.

A standard loaf not having a toasted crust was obtained. In particular, the crust consists of a light layer having the same colour as the interior and differing in that it has a lower void density and a slightly shiny external appearance. However, a variation in the moisture content or organoleptic properties between the crumb and the crust of the bread obtained was not observed.

### EXAMPLE 2

500 g of leavened dough were prepared in a standard loaf mould as mentioned in Example 1. The mould and the dough were introduced into a steam autoclave at approximately 120° C. for approximately 40 minutes. The mould containing the dough was subsequently introduced into a conventional laboratory oven and maintained at approximately 135° C. for 7.5 minutes.

As a result, a loaf having the same visual characteristics as that obtained in Example 1 was obtained in a shorter time. There were no significant differences between the organoleptic properties of the crust and the crumb.

### EXAMPLE 3

500 g of leavened dough were prepared in a standard loaf mould as mentioned in Example 1. The mould and the dough were introduced into a natural gas oven in which the flame was present in the baking area. The baking temperature was approximately 120° C. for approximately 45 minutes.

A standard loaf not having a toasted crust was obtained. The external appearance was not shiny, the crust had a colour very similar to that of the interior of the loaf and the moisture degree was very similar between the crumb and the crust.

1. Process for obtaining standard loaves which comprises introducing a mold containing leavened bread dough into a baking area, and wherein baking is carried out, at least in part, at a temperature of between 90 and 150° C.

2. Process according to claim 1, wherein baking is carried out, at least in part, at a temperature of between 100° C. and 125° C.

3. Process according to claim 1, further comprising a stage of introduction of steam into the baking area.

4. Process according to claim 3, wherein the introduction of steam is at a temperature higher than the saturation temperature at the pressure at which baking is carried out.

5. Process according to claim 1, wherein baking is carried out, at least in part, while introducing steam at a temperature of between more than 100° C. and 125° C.

6. Process according to claim 5, wherein said steam is at a temperature of between 103° C. and 125° C.

7. Process according to claim 3, wherein baking while introducing steam has a duration of between 0.5 hours and 1.17 hours.

8. Process according to claim 7, wherein said baking while introducing steam has a duration of between 0.5 hours and 0.84 hours.

9. Process according to claim 8, wherein said baking while introducing steam has a duration of between 0.58 hours and 0.75 hours.

10. Process according to claim 4, wherein the baking stage consists of a first bake in the constant presence of steam at a temperature of between 100° C. and 125° C. for a period of between 0.5 hours and 0.75 hours and a second baking stage with the initial presence of steam at a temperature of between 120° C. and 150° C. for a period of 0.08 hours and 0.17 hours.

11. Process according to claim 1, wherein, at least during a stage of baking, steam is the element responsible for heating the bread dough.

12. Process according to claim 3, wherein the baking stage consists in baking in an oven into which steam has initially been introduced, at a temperature of between 90° C. and 125° C. for between 0.83 hours and 1.17 hours.

13. Process according to claim 11, wherein the baking temperature is approximately 100° C. for approximately 1 hour.

14. Installation for the industrial production of standard loaves by a process according to claim 1, comprising at least a heating unit for baking bread dough equipped with a device for introducing steam into the baking area.

15. Installation according to claim 14, further comprising a steam heating unit.

16. Installation according to claim 14, further comprising installations for weighing ingredients, kneading, division of the dough, shaping, leavening at controlled temperature and humidity before the heating unit for baking the bread dough.

17. Installation according to claim 14, further comprising slicing, packaging and labeling installations situated after the heating unit for baking the bread.

18. A standard loaf, having a crust which is substantially the same color as the crumb.

19. A standard loaf according to claim 18, wherein the organoleptic properties of the crust are substantially identical to those of the crumb.

20. A standard loaf according to claim 18, wherein the external crust is slightly shiny.

21. A standard loaf according to claim 18, wherein the moisture degree of the crust is substantially identical to that of the crumb.
